(19) United States
(12) Patent Application Publication
(10) Pub. No.: US 2025/0264733 A1
(43) Pub. Date: Aug. 21, 2025

(54) EMBEDDED RIGID FRAME PORTIONS FOR FLEXIBLE EYEWEAR

(71) Applicant: Brent SHELDON, Miami, FL (US)

(72) Inventors: BRENT SHELDON, Miami, FL (US); Guy BROUSSEAU, JR., Marieville, CA (US)

(21) Appl. No.: 19/176,561

(22) Filed: Apr. 11, 2025

Related U.S. Application Data
(63) Continuation of application No. PCT/CA2023/051372, filed on Oct. 16, 2023.
(60) Provisional application No. 63/419,893, filed on Oct. 27, 2022.

(51) Int. Cl. G02C 5/00; G02C 1/00; G02C 5/06; G02C 5/16

(52) U.S. Cl. CPC G02C 5/008; G02C 1/10; G02C 5/06; G02C 5/16; G02C 2200/16

(57) ABSTRACT

A lens retainer for an eyewear is provided. The lens retainer includes a rigid frame portion having a body. The body includes a first surface and a second surface spaced apart from the first surface to define a thickness of the body. The second surface is adapted to provide a groove for retaining a lens. The rigid frame portion is at least partially contained within a flexible material to at least embed the thickness and the first surface of the body in the flexible material.

### CROSS-REFERENCE TO RELATED APPLICATION(S)

This application is a continuation of PCT Patent Application No. PCT/CA2023/051372 filed on Oct. 16, 2023, and claims priority to U.S. Provisional Patent Application No. 63/419,893 filed on Oct. 27, 2022, the contents of which are incorporated herein by reference in their entirety.

### TECHNICAL FIELD

The following generally relates to flexible eyewear, and in particular to embedded rigid frame portions for such flexible eyewear, for example rigid frame portions embedded in a flexible eyewear frame to receive and support the insertion of eyewear lenses.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g. by resting the arms on the user's ears or engaging their head in the temple region. Other eyewear may include other support elements such as straps or bands (e.g., in sports goggles).

Eyeglasses have traditionally utilized frames or frame components made from substantially rigid materials such as plastics, metals, or composite materials. The rigidity of these materials supports the lenses in the frames, and substantially maintains the shape of the eyeglasses such that they consistently fit on a user's head as intended. A drawback of this rigidity is that the frames can only typically withstand some flexure and can be prone to breakage or deformation.

Flexible components have been used in eyewear, for example, flexible arms and flexible portions of the eyewear frames. Various challenges can arise in construction, assembly, and use when incorporating flexible elements. For example, the flexibility should not cause the frames to deform and thus lose their shape over time. Other challenges include assembly complexities and costs associated with using multiple different materials. Components made of rigid material and components made of flexible material generally can find difficulties adhering to each other, and may require a joining mechanism that should be easy to assemble while also being durable and provide a strong joint.

Additionally, products such as eyewear that are assembled from multiple pieces and are meant to have a uniform color, at least across multiple pieces, require careful matching of colors in those pieces. However, some individual pieces or parts in the assembly may be made from different materials, which are difficult to match. For example, a multi-component product such as eyewear may have a flexible portion made from a flexible material and rigid component(s) made from a rigid material. These flexible and rigid materials typically have different surface finishes. Moreover, it can be difficult to match the color in these different materials.

### SUMMARY

In one aspect, a lens retainer for an eyewear is provided. The lens retainer includes a rigid frame portion having a body that includes a first surface and a second surface. The first surface and the second surface are spaced apart to define a thickness of the body of the rigid frame portion. The second surface is adapted to provide a groove for retaining a lens. The rigid frame portion is at least partially contained within a flexible material to at least embed the thickness and the first surface of the body in the flexible material.

In another aspect, an eyewear comprising an eyewear frame including the lens retainer is provided.

### BRIEF DESCRIPTION OF THE DRAWINGS

Embodiments will now be described with reference to the appended drawings wherein:

FIGS. 1a and 2a are perspective views of eyewear with embedded rigid frame portions in a flexible frame.

FIGS. 1b and 2b are perspective views of eyewear with embedded rigid frame portions in a flexible frame in another configuration.

FIGS. 1c, 2c, and 2d are perspective views of eyewear with embedded rigid frame portions in a flexible frame in a yet another configuration.

FIG. 3a is a cross-sectional view of a portion of the flexible eyewear frame to illustrate an embedded rigid lens retainer within a frame portion.

FIG. 3b is a cross-sectional view of a portion of the flexible eyewear frame to illustrate an embedded rigid lens retainer within a frame portion in another configuration.

FIG. 4 is a cross-sectional view of the portion of the eyewear frame shown in FIG. 3a with a lens inserted into the embedded rigid lens retainer.

FIG. 5 is an enlarged cross-sectional view of the flexible frame portion illustrating a cross-sectional profile of the embedded rigid lens retainer in the configuration shown in FIGS. 1b, 2b, and 3b.

FIGS. 6a and 6b illustrate insertion of the embedded rigid lens retainer into a prefabricated flexible frame portion.

FIGS. 7a and 7b illustrate insertion of a lens into the embedded rigid lens retainer.

FIG. 8 illustrates an embedded rigid lens retainer with additional flexible material at lower insertion points.

FIG. 9 illustrates an embedded rigid lens retainer with additional flexible material over an entire inner surface.

FIG. 10 illustrates an embedded rigid lens retainer with additional flexible material at lower insertion points, including the profile shown in FIG. 5.

FIG. 11 illustrates an embedded rigid lens retainer with additional flexible material over an entire inner surface, including the profile shown in FIG. 5.

FIGS. 12a and 12b illustrate an embedded rigid lens retainer formed by machining a base block embedded in a frame portion made from a flexible material.

### DETAILED DESCRIPTION

A flexible eyewear configuration is described in which rigid frame portions that are used to provide rigidity to portions of the eyewear are hidden or embedded in an otherwise uniform flexible frame. In this way, for example, rigid lenses can be supported within the flexible eyewear frame without requiring a multi-component or multi-surface construction, thus allowing a uniform outer surface for the application of paint or other surface treatments. Moreover, uniformity across the lens portions and flexible bridge portion can be provided while maintaining the structural rigidity to support such lenses.

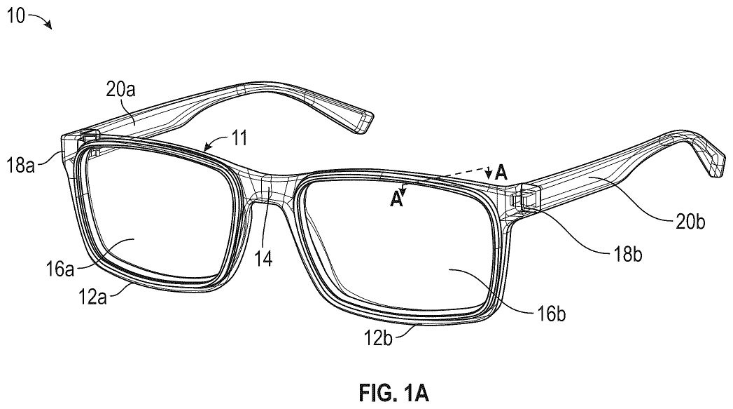

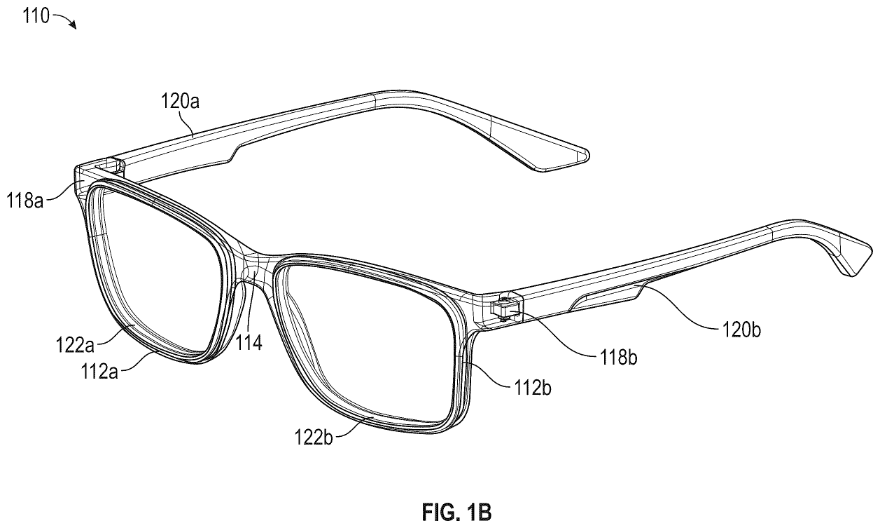

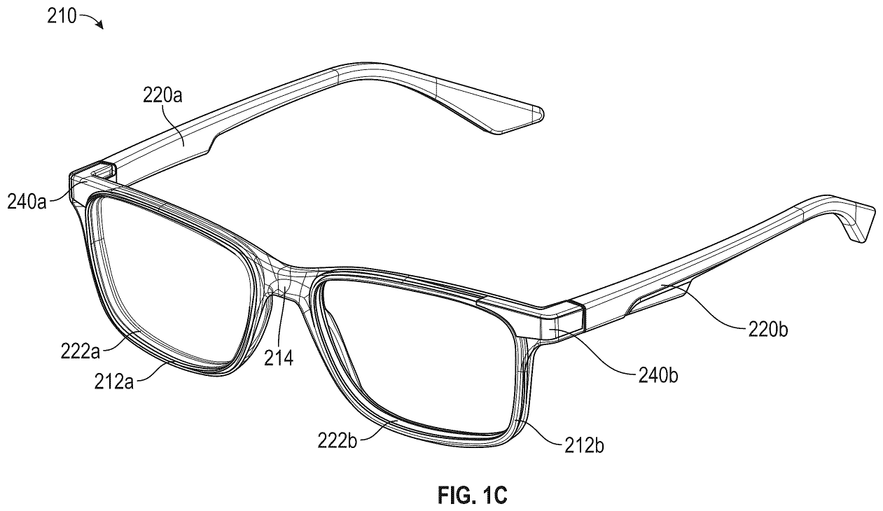

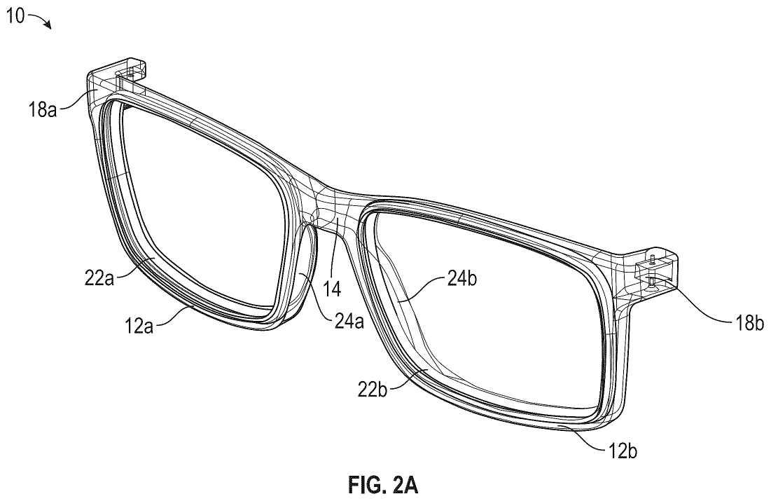

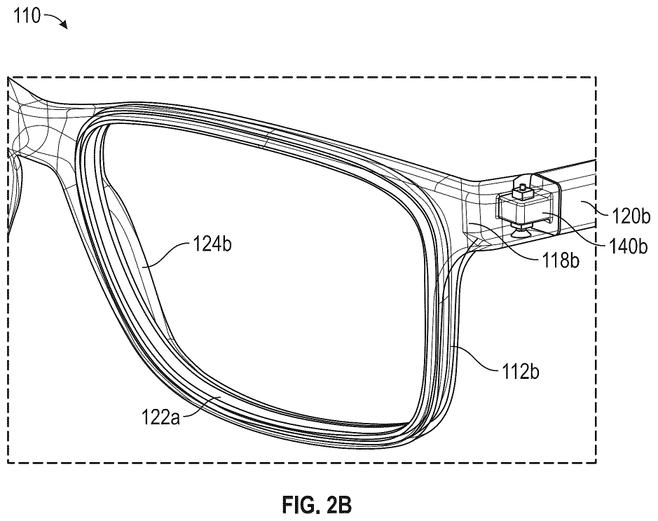

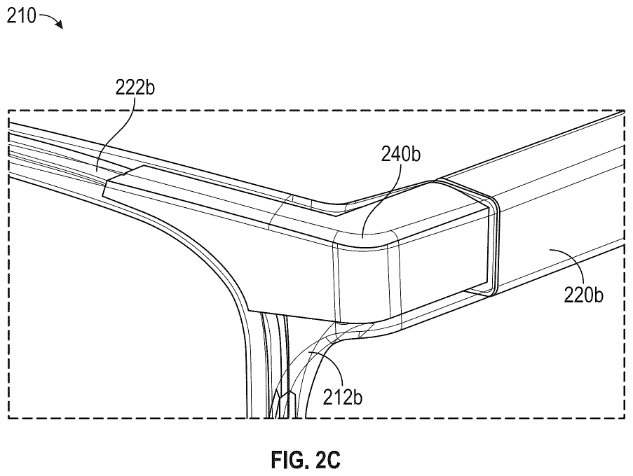

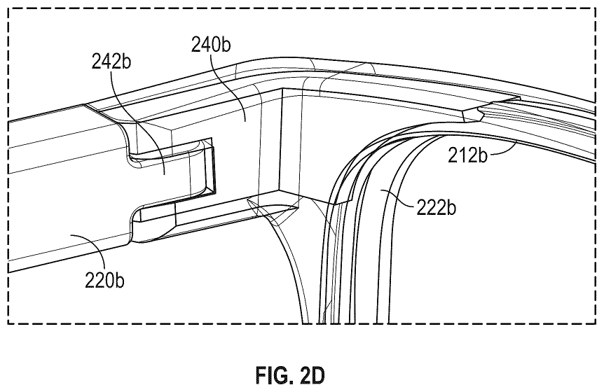

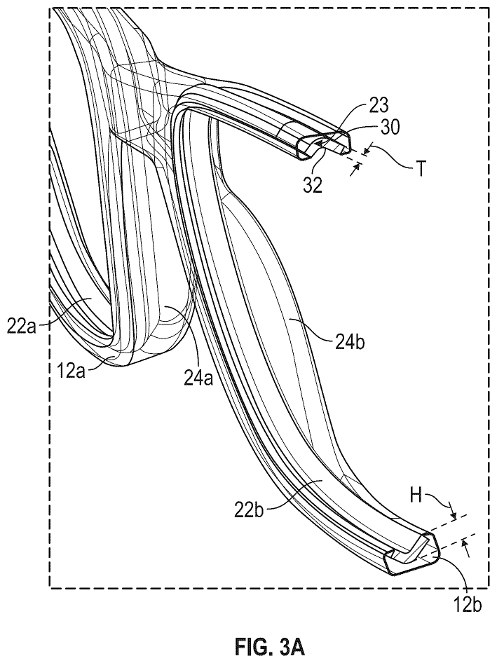

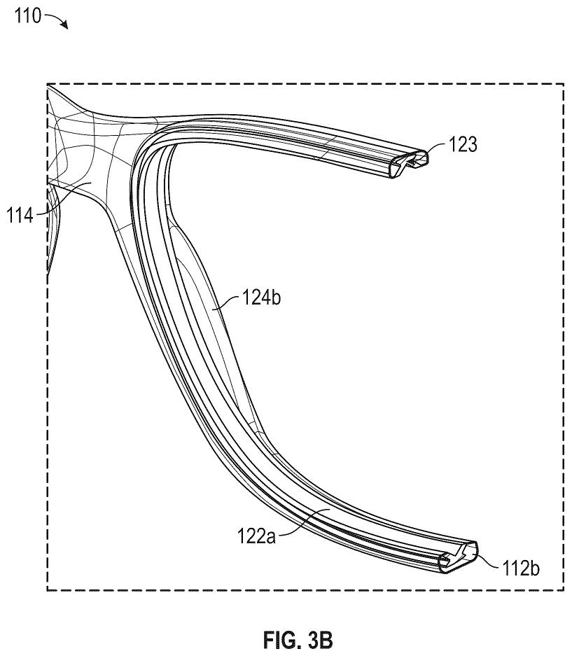

Turning now to the figures, FIG. 1a illustrates a perspective view of an example assembled eyewear 10, also referred to interchangeably herein as an eyewear assembly 10 or eyewear 10 for brevity. The eyewear 10 includes a flexible frame 11 that is defined in part by a pair of separate lens retainers 12, such as a first lens retainer 12a and a second lens retainer 12b. In an example embodiment, the lens retainers 12a, 12b may be adapted to hold respective lenses 16a, 16b using one or more embedded rigid frame portions 22a, 22b (see also FIGS. 2a and 3a), as will be described in further detail below. For example, the first lens 16a is held by first lens retainer 12a and the first embedded rigid frame portion 22a, whereas the second lens 16b is held by the second lens retainer 12b and the second embedded rigid frame portion 22b. It can be appreciated that “embedded” as used herein may include hidden, encapsulated (fully or partially), coupled to/with or otherwise integrated with the flexible material.

The eyewear 10 includes a first arm 20a connected to the first lens retainer 12a via a first hinge assembly 18a, and a second arm 20b connected to the second lens retainer 12b via a second hinge assembly 18b to support the eyewear 10 on a user's face. In some implementations, the hinge assemblies 18a, 18b may include rigid hinge components that are embedded within a flexible material that may be, for example, the same as and extend from the respective flexible lens retainers 12a, 12b. Similarly, the arms 20a, 20b can also be made of the same flexible material as that of the lens retainers 12a, 12b and can, in some examples, have rigid members embedded therein. In some implementations, the lens retainers 12a, 12b, the hinge assemblies 18a, 18b, and the arms 20a, 20b can be formed integrally along with the respective embedded rigid members, whereas in some alternative examples, the components can be formed separately and assembled in this or any other suitable configuration.

The lens retainers 12a and 12b are connected to each other via a bridge portion 14, which in an example, is a flexible bridge portion. In one embodiment, the flexible material used to form the lens retainers 12a, 12b (e.g., to surround the embedded rigid frame portions 22a, 22b) can also extend between the lens retainers 12a, 12b to likewise form the flexible bridge portion 14 in a uniform manner to provide the appearance of a single piece structure. In this way, a common paint or other surface treatment can be applied to that material without matching or discontinuities being formed. In some other examples, the flexible bridge portion 14 can be formed separately with the same flexible material as that of the lens retainers 12a, 12b and coupled to lens retainers 12a, 12b on each side to form a continuous outer surface, on which the common paint or surface treatment can then be applied. In some yet other examples, the material of the flexible bridge portion 14 can be different from that of the lens retainers 12a, 12b.

The lens retainers 12a and 12a are separated via the flexible bridge portion 14 so as to position them on either side of the user's head and to be aligned with their eyes. The flexible bridge portion 14 enables the eyewear 10 to be flexed such that the lens retainers 12a, 12b and arms 20a, 20b attached thereto can be bent or otherwise separated or twisted relative to each other. This allows, for example, the user to slightly flex the arms 20a, 20b away from each other when placing the eyewear 10 on their head, with resiliency in the flexible bridge portion 14 causing the arms 20a, 20b to return towards each other and seat against the user's head and on their ears. The flexibility also resists breakage of the lens retainers 12a, 12b by permitting them to flex, twist, and to a certain extent, fold, e.g., if the eyewear 10 falls, is sat upon by the user, is stuffed into a purse or bag, etc. Although the bridge portion 14 is described to be flexible, it may however be appreciated that other semi-flexible configurations may also be contemplated in some alternative implementations, such as embedding rigid members within the flexible bridge portion 14 or coupling the flexible bridge portion 14 to the lens retainers 12a, 12b via rigid fastening mechanism, or the like.

The first lens retainer 12a further includes or otherwise supports a first nose piece 24a, and the second lens retainer 12b includes or otherwise supports a second nose piece 24b (as shown more clearly in FIGS. 2a and 3a). The nose pieces 24 may also be referred to as, or considered to be, nose engaging portions or nose pads that are configured to support the eyewear 10 in place on the user's face. However, the nose pieces 24a, 24b shown in the figures are for illustrative purposes only and are not intended to limit the scope of claimed subject matter in any manner.

The flexible frame 11 (including the lens retainers 12a, 12b, and the bridge portion 14) may be constructed from an elastomer such as thermoplastic polyurethane (TPU), rubber or thermoplastic rubber (TRP), soft plastic, or any other suitable material. Further, the embedded rigid frame portions 22a, 22b may be made from a rigid or a semi-flexible material, such as metal, plastic, wood, acetate, or any other suitable rigid or semi-flexible material. In an example embodiment, the material of the flexible frame 11 and/or at least the lens retainers 12a, 12b can be overmolded onto the rigid frame portions 22a, 22b to have the rigid frame portions 22a, 22b at least partially embedded within the respective lens retainers 12a, 12b. In some alternative embodiments, the rigid frame portions 22a, 22b may be inserted into preformed flexible lens retainers 12a, 12b, for example, through an undercut formed in the lens retainers 12a, 12b, and be adhered to the flexible material by either frictional forces or adhesive materials or both. Further, in some implementations, the rigid frame portions 22 and the flexible material embedding the rigid frame portions 22 may be formed as continuous components to surround the entire circumferential periphery of the lenses 16. However, some other implementations, the flexible material may be formed as the flexible frame 11 to surround the entire lens 16 and the rigid frame portions 22 may be implemented as discontinuous components positioned around the lenses 16 at suitable locations. For example, rigid frame portions 22 may include four members to be located at the four sides of the lenses 16. However, any other configurations for positioning the rigid frame portions 22 may also be contemplated to achieve similar results.

Referring to FIG. 2a, the example flexible lens retainers 12a, 12b having the embedded rigid frame portions 22a, 22b are visible without the lenses 16a, 16b inserted. As shown, in an example implementation, the rigid frame portions 22a, 22b include a first surface 30 (hereinafter outer surface 30) that is completely embedded within the flexible material of the lens retainers 12a, 12b, and a second surface 32 (hereinafter referred to as the inner surface 32) that faces the lenses 16a, 16b within the lens retainers 12a, 12b. In an example embodiment, the rigid frame portions 22a, 22b are configured to provide a substrate or rigid groove into which the lenses 16a, 16b can be inserted.

Referring now to FIG. 3a, a cross-sectional view of the lens retainer 12b taken along lines A-A (shown in FIG. 1a) is illustrated. As shown, the rigid frame portions 22a, 22b (only 22b shown) has a body 23 that, in one example, has an inverted V cross-sectional profile. The body 23 includes the first surface 30 and the second surface 32 spaced apart to define a thickness T of the body 23. Similarly, the cross-sectional profile of the first surface 30 defines a height H of the body. In one example, the rigid frame portions 22a, 22b can be at least partially contained within the flexible material of the lens retainer 12b, such that at least the thickness T and the first surface 30 are embedded and the second surface 32 is exposed, and devoid of the flexible material, to provide a rigid groove against which the lens 16b (not shown in FIG. 3a) can be inserted. Further, in some implementations, the rigid frame portions 22a, 22b is contained within the flexible material 30 such that the flexible material covers or embeds the entire height H of the body 23 while leaving the second surface 32 exposed to receive the lens 16. For example, the lens 16b can be “snapped” into place within the groove provided by the second surface 32 of the rigid frame portion 22b. As shown, the opposite first surface 30 of the rigid frame portion 22b sits embedded within the flexible material of the lens retainer 12b and can be adhered thereto (e.g., via an overmolding process or via another adhesive applied between the materials or by a fasteners). In some other examples, the embedded rigid frame portions 22a, 22b can be assembled in the eyewear 10 by inserting into a preformed flexible frame having complementary receptacles and held in place by either frictional forces, fasteners, or a suitable adhesive.

In some other examples, the rigid frame portions 22a, 22b may be completely embedded within the flexible lens retainers 12a, 12b such that a thin layer of flexible material coats the second surface 32 to provide a coated or hidden rigid groove into which the respective lenses 16a, 16b can be inserted. This way, even the lens retaining groove can be painted or surface treated as part of the single surface of the eyewear 10.

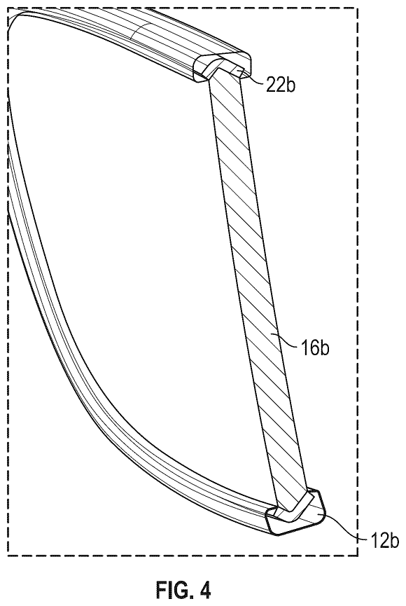

FIG. 4 illustrates the same cross-sectional view as that shown in FIG. 3a with a lens 16b inserted such that it snaps into the groove provided by the second surface 32 of the rigid frame portion 22b. In this way, the flexible frame, and its lens retainers 12a, 12b can include the same material as that of the flexible bridge portion 14 while having the structural integrity to hold the lenses 16 in place.

Referring now to FIGS. 1b, 2b, and 3b, another example configuration for an eyewear 110 is illustrated. Reference numerals in FIGS. 1b, 2b, and 3b are similar to those in FIGS. 1a, 2a, and 3a using the prefix “1” and thus all details are not reiterated. In this configuration, rigid arms 120a, 120b are connected to rigid hinge members 140a, 140b (more clearly shown in FIG. 2b). Similar to the configuration explained above, the rigid arms 120a, 120b and the hinge members 140a, 140b can also be embedded within a flexible material in a similar manner.

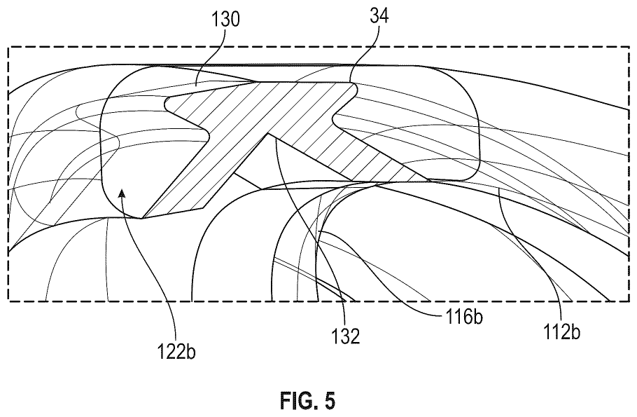

Further, as shown in FIG. 3b, the cross-section of the rigid frame portions 122a includes a cross-sectional profile different from that of the rigid frame portions 22a, 22b. In this example, the body 123 of the rigid frame portions 122a, 122b (only one shown in FIG. 3b) may include the outer surface 130 to have a complex ribbon-like profile with a wide top 34 (shown more clearly in FIG. 5) and the inner surface 132 to have an inverted V-shaped profile. In this example, the profile of the rigid frame portions 122 and the outer surface 130 are adapted to provide more contact surface area to promote adhesion to the flexible material, for example, during the overmolding process. As will be understood, the cross-sectional profiles of the rigid frame portions may be varied to include various profiles of the outer and inner surfaces to achieve similar results.

In this example implementation, the rigid frame portions 122a, 122b may be contained within the flexible material such that the thickness T1 of the body 123, including the thickness T2 at the top 34, along with the outer surface 130 is embedded within the flexible material and the inner surface 132 is exposed to receive the respective lens 16 therein. In some alternative implementations, the lens retainers 112a, 112b may be preformed using the flexible material and can have preformed receptacles complementary to the shape and size of the rigid frame portions 122a, 122b such that the rigid frame portions 122a, 122b can be inserted and adhered thereto, for example, by frictional force, fasteners, and/or adhesives.

Referring now to FIG. 1c, a yet another example configuration for an eyewear 210 is illustrated. Reference numerals in FIG. 1c are similar to those in FIG. 1a using the prefix “2” and thus all details need not be reiterated. In this configuration, rigid arms 220a, 220b are connected to embedded rigid temple members 240a, 240b, (more clearly shown in FIGS. 2c and 2d). As seen in FIG. 2d, hinge members 242a, 242b connect the arms 220a, 220b to the embedded rigid temple members 240a, 240b. Further, in some examples, the temple members 240a, 240b can be coupled to the embedded rigid lens retainers 222a, 22b and overmolded with the same flexible material while providing additional structural support for the arms 220a, 220b. The profile of the embedded rigid lens retainers 222a, 222b, the outer surface 230 and the inner surface 232 can be similar to either that shown in one of FIG. 3a or 3b or have an entirely different cross-sectional profile.

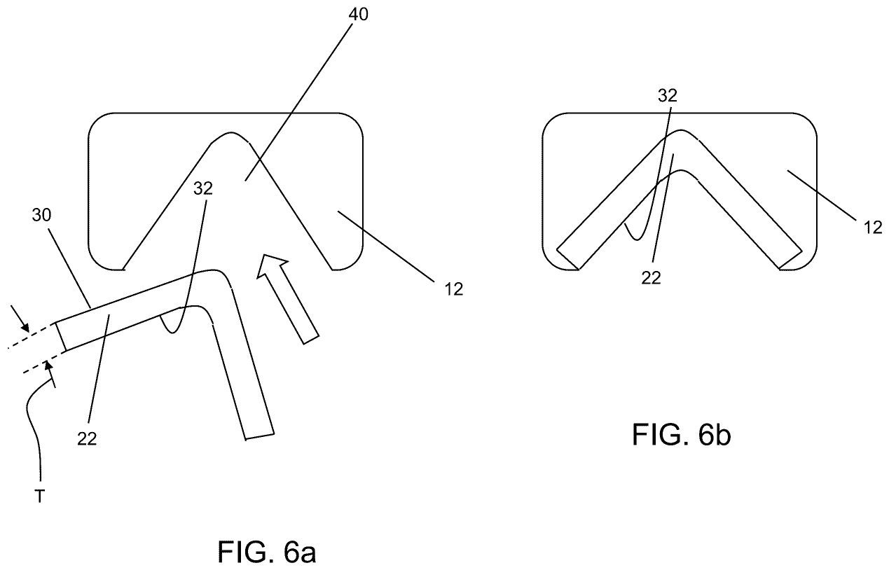

While the rigid frame portions 22, 122, 222 can be overmolded with the flexible material used to form the surrounding lens retainer 12, 112, 212, in some other implementations, a manual insertion and assembly process can also be implemented. For example, one such manual insertion is shown in FIGS. 6a and 6b. In FIG. 6a, a preformed lens retainer 12 is shown with a receptacle or channel 40 for accepting the insertion of the rigid frame portion 22. The shape and size of the receptacle or channel 40 within the preformed lens retainers 12 can be complementary to the shape and size of the corresponding rigid frame portions 22, which in this example, is an inverted V or triangular profile. The term “complementary” will include any shapes and sizes that are identical or slightly larger or smaller with respect to the shape and size of the rigid frame portions 22, so as to allow snap or friction insertion of the rigid frame portion 22 within the receptacle 40. As shown in FIG. 6b, when assembled, the outer surface 30 of the rigid frame portion 22 abuts the corresponding surface of the receptacle 40, and be adhered thereto, for example, by friction force, fasteners, or adhesives. The rigid frame portion 22, in the assembled state, is contained within the flexible lens retainer 12 such that the thickness T and the outer surface 30 of the rigid frame portion 22 are embedded within the flexible material while the inner surface 32 is left exposed.

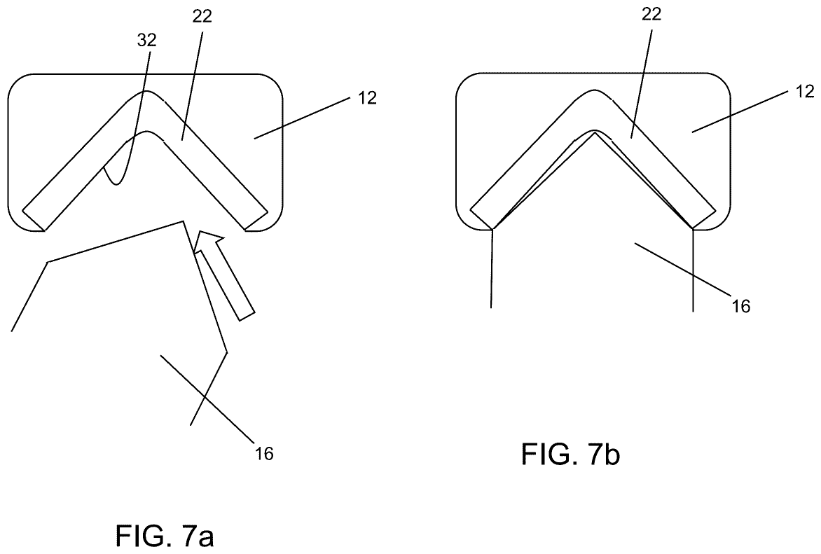

Once the rigid frame portions 22, 122, 222 are assembled into the lens retainers 12, 112, 212, either by overmolding or by manual insertion, the lenses 16 can be inserted into the groove provided by the inner surface 32, 132 of the rigid frame portions 22, 122, 222. FIGS. 7a and 7b illustrate one such example of a lens assembly process. As shown in FIG. 7a, the inner surface 32 of the rigid frame portion 22 is exposed to provide a rigid groove against which the lens 16 can be inserted. The lens 16 may also include a profile complementary to the profile of the inner surface 32 so as to be fitted therein. As seen in FIG. 7b, the rigid frame portion 22 becomes hidden from view once the lens 16 is inserted in place, thereby providing a clean and uniform outer surface while creating suitable structural integrity to hold the lens 16 in place.

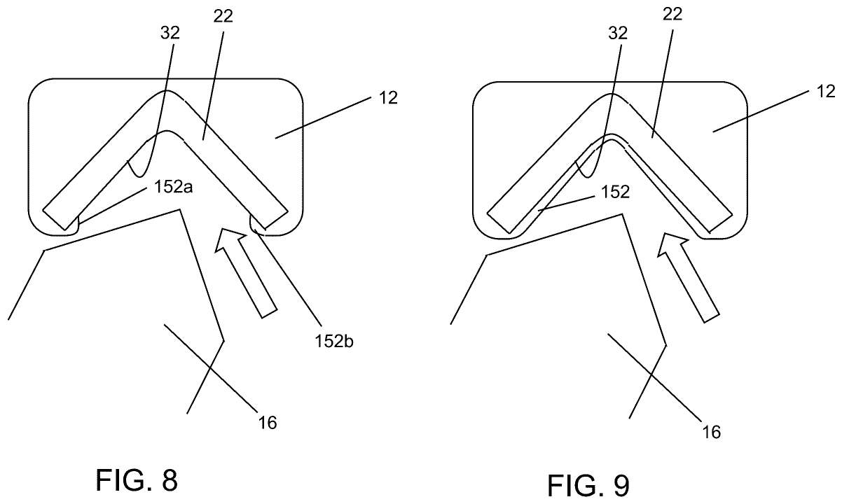

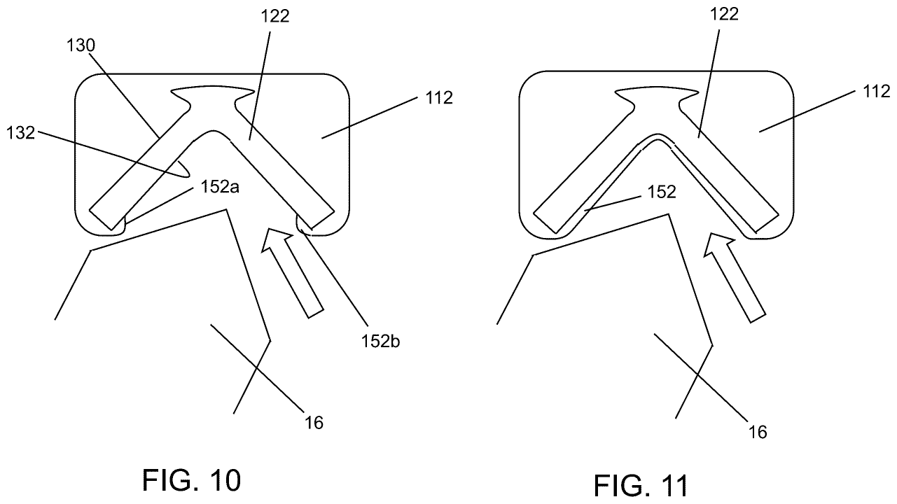

Referring now to FIGS. 8 to 11, alternative example implementations for embedding the rigid frame portion 22, 122 (also applicable to the rigid frame portion 222) within the flexible material are shown. As explained above, while the rigid frame portion 22, 122 can include a completely exposed inner surface 32, 132, other variations are possible. For example, as shown in FIGS. 8 and 10, first and second additional flexible material portions 152a, 152b can partially cover the inner surface 32, 132 to also provide additional frictional engagement with the lens 16, when inserted. In some implementations, the additional material portions 152a, 152b may extend from the lens retainers 12, 112, whereas in some other implementations, they can be formed separately and attached to the rigid frame portion 22, 122 to cover a portion of the inner surface 32, 132. Further, as shown in FIGS. 9 and 11, in a yet another example implementation, the entire inner surface 32, 132 can be coated with a thin layer of the flexible material to completely hide the embedded rigid frame portion 22, 122, even when a lens 16 has not yet been inserted. It can be appreciated that the amounts and extent of coverage shown in FIGS. 8 to 11 are purely illustrative and any other desired coverage of the inner surface 32 is possible.

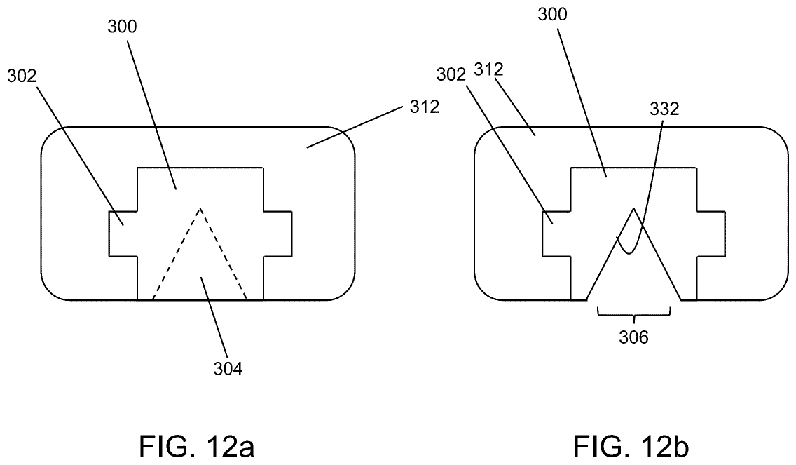

Referring now to FIGS. 12a and 12b, a yet another example configuration of the rigid frame portion 300 and a lens retainer 312 is shown. In the illustrated example, the rigid frame portion 300 can include projections 302 or other profile elements extending, for example, from the outer surface 302 to provide additional contact surface, for example, to maintain securement within the lens retainer 12 or for the overmolding process. In some implementations, as shown in FIG. 12a, the lens retainer 12 can be produced along with the embedded rigid frame portion 300 as a solid component with a to-be-machined portion 304 shown in dashed lines. FIG. 12b illustrates that after machining the portion 304, a ridge 306 is formed with an inner surface 332 that provides the groove against which the lens 16 can be inserted.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A lens retainer for an eyewear, the lens retainer comprising:
a rigid frame portion having a body including:
a first surface; and
a second surface spaced apart from the first surface to define a thickness of the body, the second surface being adapted to provide a groove for retaining a lens,
wherein the rigid frame portion is at least partially contained within a flexible material to at least embed the thickness and the first surface of the body in the flexible material.

2. The lens retainer of claim 1, wherein the second surface is exposed and devoid of the flexible material to define a rigid groove for retaining the lens.

3. The lens retainer of claim 1, wherein the second surface is coated with a layer of flexible material to provide a hidden rigid groove for retaining the lens.

4. The lens retainer of claim 1, wherein the second surface is partially embedded within the flexible material.

5. The lens retainer of claim 1, wherein the flexible material includes one or more of thermoplastic polyurethane (TPU), rubber or thermoplastic rubber (TRP), and soft plastic.

6. The lens retainer of claim 1, wherein the rigid frame portion is made of a rigid or a semi-flexible material including one or more of metal, plastic, wood, and acetate.

7. The lens retainer of claim 1, wherein the flexible material is overmolded onto the rigid frame portion.

8. The lens retainer of claim 1, wherein the flexible material is preformed as a flexible frame with a receptacle to receive the rigid frame portion therein.

9. The lens retainer of claim 8, wherein the receptacle in the preformed flexible frame includes a shape and size complementary to a shape and size of the rigid frame portion.

10. The lens retainer of claim 8, wherein the rigid frame portion is mechanically inserted within the receptacle and adhered thereto by one or more of friction force, adhesives, or fasteners.

11. The lens retainer of claim 1, wherein each of the first surface and the second surface includes an inverted V-shaped cross sectional profile.

12. The lens retainer of claim 1, wherein the first surface includes a ribbon-like cross-sectional profile having a wide top surface to provide a large contact area for engaging with the flexible material.

13. The lens retainer of claim 1, wherein the body includes one or more projections extending from the first surface, the one or more projections being configured to be embedded within the flexible material.

14. The lens retainer of claim 1, wherein the rigid frame portion at least partially contained within the flexible material is preformed as a solid component having a predefined portion to be machined to form the second surface.

15. An eyewear comprising an eyewear frame including at least one lens retainer of claim 1.

16. The eyewear of claim 15 comprising:
a pair of lens retainers including the at least one lens retainer and connected to one another via a bridge portion; and
an arm connected to each of the pair of lens retainers via a respective hinge assembly, wherein the arm comprising a rigid member embedded within a flexible material.

17. The eyewear of claim 16, wherein the bridge portion is a flexible bridge portion.

18. The eyewear of claim 16, wherein the bridge portion includes a rigid member embedded within the flexible material.

19. The eyewear of claim 15 further comprising a temple member connected to the rigid frame portion on one end and to the respective arm on the other end via a hinge assembly.

20. The eyewear of claim 19, wherein the temple member includes a rigid member embedded within the flexible material.
